(19) United States
(12) Patent Application Publication
(10) Pub. No.: US 2004/0241369 A1
(43) Pub. Date: Dec. 2, 2004

(54) Self-adhering roll roofing product with tapered selvage edge and method of making

(76) Inventors: Joseph Pressutti, Fresno, CA (US); Lawrence Penner, Fresno, CA (US); Frank A. Gardanier, Fresno, CA (US); Walter Becker, St. Petersberg, FL (US)

Correspondence Address: Terry L. Miller, 24832 Via San Fernando, Mission Viejo, CA, 92692, US

(21) Appl. No.: 10/453,699

(22) Filed: Jun. 2, 2003

(51) Int. Cl. B32B 9/00

(52) U.S. Cl. 428/40.1; 428/157; 428/143

(57) ABSTRACT

A self-adhesive roll roofing product is configured to form lap joint seams in which a selvage edge portion of one strip of the roofing product is overlapped and bonded to an opposite marginal side edge portion of a next-successive strip of the roofing product. In order to desirably form such a lap joint seam that is resistant to moisture entrapment and blistering, the selvage edge portion of the roofing product is tapered and configured to form a lap joint seam substantially free of void volume and trapped air. A method of making the self-adhesive roll roofing product is also described.

### BACKGROUND OF THE INVENTION

1. Field of the Invention

This invention is in the field of roofing materials. More particularly, this invention relates to the waterproof membrane portion of a roof structure, and especially to a roll roofing product for making such a waterproof membrane, which product is self-adhering and has a tapered selvage edge. Such a roll roofing product may be applied to a roof structure that is substantially flat, is only slightly pitched, or which is pitched to any desired angle. During installation the roll roofing product is unrolled and is applied to the roof structure in successive elongate strips that self-adhere (i.e., the roll roofing product is pressure-sensitive and adhesive on its lower face), and which strips are slightly overlapped and sealingly unite to form a comprehensive waterproof membrane over the roof structure. The tapered selvage edge of a first strip of the roll roofing product is overlapped and sealingly adhered to by a marginal edge portion of a next-successive strip of the roll roofing product to form a water proof lap joint seam. This tapered selvage edge of the present roll roofing product allows the formation of a lap joint seam that is particularly resistant to moisture entrapment and blistering.

A method of making the roll roofing product is also disclosed.

2. Related Technology

Generally, the roof structure of a building includes a structural portion, which may include roof beams or trusses, possibly a grid of stringers carried on the beams or trusses, and a roof deck or sheeting which is carried on the stringers. The roof deck or sheeting may be carried directly upon the roof beams or trusses in some roof structures. Upon this structural portion of the roof is generally disposed an outwardly (i.e., upwardly) exposed water proof membrane structure. The water proof membrane structure prevents water (i.e., from various forms of precipitation) from penetrating the roof structure. Generally, the roof is provided with a system of drains, and possibly with a system of gutters, along with drain pipes or down spouts, to carry the precipitation water away.

Such a roof structure may be substantially flat, or may be slightly pitched. Alternatively, such a roof structure may be pitched to any desired degree. Historically, flat or slightly pitched roofs have been of “build up” construction. That is, the conventional roll sheet roofing is usually 4 foot wide, is utilized at a roofing site in the form of a rolled elongate strip which may be 15 feet or more in length, and would generally be applied by a “hot mop” method. In such a “hot mop” method hot molten tar is carried in buckets up a scaffolding from the ground or is pumped from a tar heater on the ground to be delivered by a temporary pipe line arrangement to the roof. This hot tar is then mopped or otherwise spread on the seams and over the face of the sheet roll roofing to seal the seams and provide an additional water proof layer. Generally granular mineral material is spread over the surface of the roof to provide protection for the tar from ultraviolet radiation in sun light.

Alternatively, after the structural portion of the roof is completed, one or more layers of “tar paper” in the form of strips or sheets from a roll are put down on the roof decking or sheeting, and one or more layers of roll roofing material are then applied over the “tar paper.” The strips of roofing material are slightly overlapped at their edges, and the roof membrane may include several layers of such overlapped strips with the strips in each successive layer running perpendicular to the preceding layer. With conventional roll roofing materials not using the “hot mop” method of installation, the overlapping edges or seams of the roll roofing material are “torched” or heated with a flame during installation to meltingly unite the asphaltic material of the adjacent stripes of roll roofing material. Here to, such “torched” seams are then themselves protected from the deteriorating effects of ultraviolet light (i.e., the ultraviolet portion of sunlight) by the application of a sprinkled coating of granular material applied while the melted asphalt material is still molten and tacky. Of course, using a torch on a roof with molten asphalt present creates a considerable fire hazard.

Understandably, such conventional roofing practices which involve the use of hot molten tar, and of large torches, frequently result in a worker being burned by the tar or torch. Further, as is well understood by anyone who has been within even a few hundred feet of such a roofing project, the use of hot molten tar releases large amounts of noxious VOC's (i.e., volatile organic compounds) into the atmosphere. Roofing workers who are exposed to these VOC's over a period of time are known to suffer health problems that range from mild (i.e., temporary headache) to more severe problems, including respiratory difficulties.

Still further, molten roofing tar is flammable, and roofing torches provide a ready ignition source. Consequently, the conventional hot tar methods of roofing have resulted in many roof fires, and in structure fires when a roofing fire spreads before it is contained. Even in cases in which a roof fire results but is stopped before it spreads to the structure, the roofers are at risk of injury as they attempt to put out the fire. In some areas, local fire departments and Fire Marshals require hot tar roofing projects to be carried out under a “hazard watch” condition, in which local fire stations are informed of the project, and have an emergency response plan worked out ahead of time for use in the event that a roof fire starts.

More recently, self-adhering types of roll roofing materials have become popular. These self-adhering types of roll roofing materials are simply unrolled onto the roof structure as a release sheet is removed from the underside of the material, and a pressure sensitive adhesive (i.e., such as asphalt) on the underside of the roll roofing material adheres the roofing material in place. With this conventional self-adhesive type of roll roofing material, no hot mopping or torching of seams is required.

However, experience has shown that the conventional self-adhesive roll roofing materials are also subject to moisture entrapment and blistering at the seams. This moisture entrapment and blistering does not necessarily result from moisture penetrating the roofing material from above and becoming trapped in a seam, although that may sometimes happen. More frequently, however, the moisture entrapment and blistering results simply from water vapor penetration of the roof structure from below (i.e., from within the building) and condensation of this water vapor as it nears the colder outside environment.

### SUMMARY OF THE INVENTION

In view of the deficiencies of the conventional related technology, it is an object of this invention to overcome one or more of these deficiencies.

Particularly, it is an object for this invention to provide a self adhering type of roofing material and method which allows the roofing materials to be applied to a roof in such a way that the entrapment of moisture and the potential for blistering at the seams of the roofing material is substantially eliminated.

Another object for this invention is to provide a roofing material and method having a tapered or feathered selvage edge portion, which selvage edge portion is overlapped and bonded to a marginal edge portion of a next-successive strip of the roofing material on a roof, thus providing a lap seam joint that is substantially free of moisture trapping void spaces.

One particularly preferred embodiment of the invention provides an elongate strip-like self-adhesive roofing product, the roofing product comprising an elongate strip-like, web of flexible fibrous material having a pair of opposite faces and a pair of elongate opposite side edges; a pair of layers of asphaltic material, each one of the pair of layers of asphaltic material sandwiching the elongate web of flexible material therebetween, and being congruent with a respective one of the pair of opposite faces of the web of flexible material and bonding thereto so that each of the pair of layers of asphaltic material has a pair of elongate opposite side edges aligning with the web of flexible material; a bottom one of the pair of layers of asphaltic material carrying a release sheet removably securing thereto and covering the one layer of asphaltic material; the top one of the pair of layers of asphaltic material defining an elongate major surface portion extending across the roofing product from a first one of the pair of opposite side edges thereof toward but short of the second one of the pair of opposite side edges, the major surface portion carrying granular material embedding in the top layer of asphaltic material; and the top layer of asphaltic material also defining an elongate selvage edge portion extending from the second side edge to the major surface portion and increasing in thickness away from the second side edge.

Accordingly, the present invention according to one particularly preferred embodiment provides a method of making a roll roofing product, the method comprising steps of providing an elongate strip of roofing material having spaced apart opposite side edges and an elongate first layer of asphaltic adhesive material bonding to one face of an elongate web of fibrous material and extending between the opposite side edges; providing a removable release sheet covering the first layer of adhesive material; providing an elongate second layer of asphaltic material bonding to an opposite face of the elongate web of fibrous material; providing a field of protective granular material covering a major portion of the second layer of asphaltic material and extending from one side edge toward but short of the other opposite side edge to leave an elongate selvage edge portion free of granular material; providing for the second layer of asphaltic material to decrease in thickness in the selvage edge portion from the field of protective granular material toward the other opposite side edge.

Other objects, features, and advantages of the present invention will be apparent to those skilled in the art from a consideration of the following detailed description of a preferred exemplary embodiment thereof taken in conjunction with the associated figures which will first be described briefly.

### BRIEF DESCRIPTION OF THE DRAWING FIGS.

FIG. 1 provides an end elevation view of a roll of the roofing product, from which a strip of the roofing product is being unrolled;

FIG. 2 is a fragmentary cross sectional view taken at line 2-2 of FIG. 1;

FIG. 3 is a fragmentary cross sectional view similar to that of FIG. 1, but showing a manufacturing intermediate product during the process of making the present roofing product;

FIG. 4 is a fragmentary cross sectional view similar to that of FIGS. 2 and 3, but showing a manufacturing step subsequent to that of FIG. 3, producing a subsequent manufacturing intermediate product;

FIG. 5 is a fragmentary cross sectional view similar to that of FIGS. 2-4, but showing another step of the manufacturing process and another subsequent manufacturing intermediate product;

FIG. 6 is a fragmentary cross sectional view showing two successive strips of the roll roofing product applied to a roof structure, and forming a waterproof and blister resistant lap joint seam; and

FIG. 7 is a fragmentary view of a machine that may be used in the making of the present roll roofing product, and corresponds to the manufacturing intermediate products seen in FIGS. 3 and 4.

### DETAILED DESCRIPTION OF EXEMPLARY PREFERRED EMBODIMENTS OF THE INVENTION

While the present invention may be embodied in many different forms, disclosed herein is a specific exemplary embodiment that illustrates and explains the principles of the invention. In conjunction with the description of this embodiment, a method of practicing the invention is described. It should be emphasized that the present invention is not limited to the specific embodiment illustrated and described.

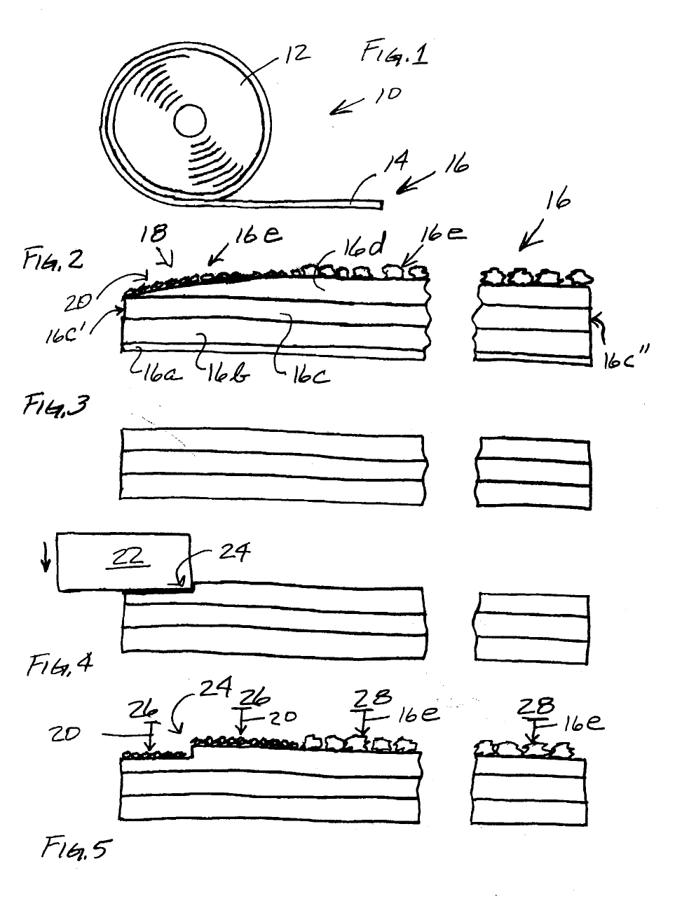

Referring first to FIG. 1, a roll of roofing material or product is generally referenced by the numeral 10. The roll 10 of roofing material includes a product roll 12 including many wraps of an elongate strip 14 of the roofing product 16. The elongate roofing product strip 16 is not limited to any particular width or length. However, the width of the strip 16 may be four (4) feet, for example, while the length of the strip rolled up in to roll 12 is perhaps 16 to 20 feet.

Considering FIG. 2, it is seen that the roofing product 16 is a five (5) layer construction, with a width dimension extending from side to side of FIG. 2. The product 16 is not limited to any particular number of layers, and the present embodiment is exemplary only. That is, a roofing product embodying the present invention may have fewer than five layers, or may have more than five layers. For clarity of illustration, only a portion of the width of the product 16 is shown in FIG. 2. Further, those ordinarily skilled in the pertinent arts will immediately recognize that the thickness of the roofing product 16 is exaggerated in FIG. 2 (again for clarity of illustration), while the relative thickness of the various layers is not to scale. Giving closer attention to the roofing product 16 of FIG. 2, it is seen that this five (5) layer product includes a layer 16a of removable release sheet material. An example of such a removable release sheet material is polypropylene sheet material in a thickness of about 5 to 10 mils (i.e., 0.005 to 0.010 inches thickness). The release sheet 16a is not limited to any particular thickness or material. Importantly, though, the release sheet 16a removably adheres to a layer 16b of adhesive asphaltic material 16b.

Sandwiched between the layer 16b of adhesive asphaltic material and a second layer 16d of asphaltic material is a fibrous layer 16c of felted or woven material. The fibrous layer 16c may be made of felted or woven polyester fibers, for example. Alternatively, the layer 16c may be made of felted or woven glass fibers (i.e., of fiberglass). Still alternatively, the layer 16c may be made of a combination of fibers, and this layer may be constituted by a method other than felting or weaving. However, the layer 16c provides structural integrity and flexibility for the roll roofing product 16, as will be well understood by those ordinarily skilled in the pertinent arts. As will be further described below, during manufacturing of the roll roofing product 16 the fibrous layer 16c in the form of a moving elongate web of material is coated on each of its opposite faces and from side to side (i.e., between the opposite side edges 16c′ and 16c″ with asphaltic material which not only coats and bonds with the fibrous layer 16c, but penetrates into the material of this layer. As will be seen in FIG. 2, these two layers 16b and 16d of asphaltic material are preferably substantially uniformly thick on each side of the web 16c of fibrous material, although the invention is not so limited.

Applied onto and embedded at least partially into and bonding to the layer 16d of asphaltic material is a protective cover layer 16e of granular material. The cover layer 16e is in two parts. That is, the layer 16e includes a major field 16f of relatively large granular material extending from the side edge 16c″ toward and almost but not completely to the opposite side edge 16c′. Viewing FIG. 2, this major field portion 16f of the granular layer 16e is toward the right-hand side of the Figure. With a roll roofing product that is four (4) feet wide (i.e., 48 inches wide), the major field 16f will preferably be about 44 inches wide. However, as is seen in FIG. 2, the major field portion 16f of relatively large granular material stops short of the opposite side edge 16c′. The larger granular material of this major field 16f may be naturally or artificially colored in order to provide color and interest to the roofing material 16. Further, this granular material is effective to cover, shield, and protect the asphaltic material of layer 16d against deterioration by exposure to ambient ultraviolet light (i.e., from sun light).

Further considering the granular layer 16e, it is seen that within a tapering selvage edge portion 18 of the product 16, the cover layer 16e includes a minor field portion 18 in which the granular material 16e covering the asphaltic layer 16d is fine dimension mineral material 20 (i.e., sand, for example). In a 48 inch wide roll roofing product, the selvage edge and minor field portion 18 is preferably 4 inches wide. The sand cover layer 20 over selvage edge portion 18 is effective to decrease the tackiness and adhesiveness of the asphaltic material of layer 16d in portion 18 so that the product 16 does not undesirably stick to manufacturing machines used in the making of the product 16, and also does not undesirably stick to itself in the wraps of roll 12. It will be understood that the sand portion 20 of granular layer 16e is a form of non-stick coating. Thus, other forms of non-stick coatings or release films may be utilized on the tapered selvage edge portion 18 for the same purpose.

Considering FIGS. 3 and 7, a manufacturing intermediate article 16g is shown in essentially the same fragmentary end cross sectional view as was utilized for FIG. 2. However, it is to be noted that the manufacturing intermediate article 16g of FIG. 2 has a substantially uniform thickness across its entire width. In the FIG. 3, the material 16g may be imagined as moving perpendicularly to the plane of the Figure and toward the viewer. Further, it is seen that the manufacturing intermediate article 16g has a substantially uniform thickness from side edge 16c′ to side edge 16c″. The manufacturing intermediate article 16g has such a substantially uniform thickness because the layers 16b and 16d have been applied to web 16c of fibrous material in substantially uniformly thick layers across the entire width of the material 16c, as was described above. However, it should be noted and should be kept in mind during the following description of the manufacturing process of making the product 16, that the top layer 16d of asphaltic material could be applied to web 16c in a layer that is substantially uniformly thick across most of its width (i.e., in the major field portion), and which has a decreasing thickness in the selvage portion 18 as the side edge 16c′ is approached.

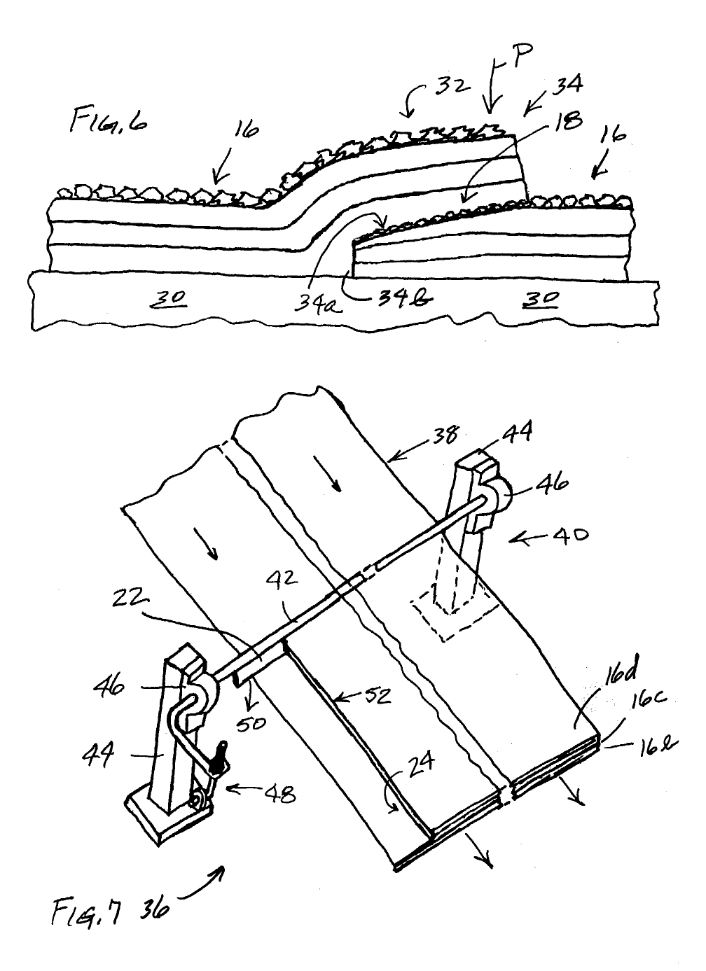

Viewing now FIGS. 4 and 7, the manufacturing intermediate article 16g of FIG. 3 is seen as and immediately after the article encounters a stationary scraper or doctor blade 22. That is, the manufacturing intermediate article is still to be seen as moving toward the view and perpendicularly to the plane of FIG. 4. This stationary doctor blade 22 forms an elongate rabbet 24 in the selvage edge portion 18 of the manufacturing intermediate product (now referenced with numeral 16h). It will be noted that the rabbet 24 does not extend from side edge 16c′ entirely across the selvage edge portion 18. Preferably, the rabbet 24 extends from the side edge 16c′ a fraction of the way across the selvage edge portion 18. Most preferably, the fractional part of the selvage edge portion 18 which is subjected to the doctor blade 22, and has rabbet 24 formed in it is from one-third to one-half of the width of the portion 18. Further, the rabbet 24 does not remove the material of layer 16d entirely down to the fibrous layer 16c. Instead, the penetration of the doctor blade 22 into the asphaultic material of the layer 16d (as well as the width of the rabbet 24) is controlled for a purpose to soon be explained.

Next, the sand 20 is dropped on the selvage edge portion 18, as is represented by the similarly numbered arrows in FIG. 5. So to, the granular material 16e is dropped on the major field portion 16f, as is represented by the arrows of FIG. 5 indicated with the numeral 16e. But, importantly, FIG. 5 also indicated by the numbered cross bars 26 and 28 on the arrows 20 and 16e, that the material is not simply dropped on the manufacturing intermediate article 16h, but is pressed downwardly in order to accomplish two goals. The first of these goals is to partially embed the granular material of the layer 16e (that is, both the granular material of the major field 16f, as well as the sand 20 of the selvage edge portion 18) into the layer 16d of asphaltic material (recalling FIG. 2). The second objective of the application of pressure as is indicated by the numerals 26 and 28 is the “smearing or redistribution of the malleable asphaltic material in the selvage edge portion 18 so as to preferably change the contour of this selvage edge portion from the step-wise decrease in thickness as seen in FIGS. 4 and 5 into the tapering decrease in thickness as is seen in FIG. 2.

In order to accomplish the change in the contour of the product from that of FIG. 5 to that of FIG. 2, the product of FIG. 5 is trained about a large warm drum or roller (not seen in the drawing Figures) with the top granular coated surface contacting the drum, and with the web 16c of material being under tension such that the layer 16d of asphaltic material tends to flow somewhat, while the granular material 16e and sand 20 embeds into this layer 16d. Embedding of granular material into roll roofing material or into shingle material by the use of such a drum or roller operation is well known in the pertinent arts. However, use of such a drum or roller operation to simultaneously redistribute and re-contour an upper layer of asphaultic material in order to contour a tapering selvage edge on a roll roofing product is believed by the Applicants to be entirely novel.

Now giving FIG. 7 additional attention, it is seen that a portion 36 of a manufacturing machine that may be used in making the product 16 is diagrammatically depicted. The machine portion 36 accommodates a span or elongate moving web 38 of the coated three layer manufacturing intermediate article 16g as is seen in FIG. 3, and this article moves as is indicated by the arrows toward a doctor blade 22. The machine portion 36 includes a support and positioning structure (generally referenced with the numeral 40) for the doctor blade 22. This structure 40 includes a transverse shaft 42 spanning above the web 38 and a pair of spaced apart support columns 44 carrying bearing blocks 46 which pivotally receive the shaft 42. The doctor blade 22 is carried by the shaft 42, and engages against the web 38 of moving manufacturing intermediate product. For the convenience of the reader, reference indicia have been placed on FIG. 7, indicative of the planes at which FIGS. 3 and 4 are taken.

Further, the machine portion 36 includes an adjustable pivot mechanism 48 for adjusting and holding the shaft 42 in a selected pivotal position such that the doctor blade scrapes a rabbet 24 of desired depth into the manufacturing intermediate article passing this stationary doctor blade. As a result of the scraping of the rabbet 24 into the moving manufacturing intermediate product as is seen in FIG. 7, a portion of the asphaltic material drops over the edge 16c′, as is indicated by arrow 50. Another part of the scraped asphaultic material forms a minor ridge 52 adjacent to the rabbet 24. However, as was explained earlier with reference to FIG. 5, the pressing of the granular material 16e and 20, combined with the simultaneous re-contouring of the layer 16d, is effective to eliminate the ridge 52.

Turning now to a consideration of FIG. 6, an example of a self-adhesive, blister-resistant lap joint 34 is seen. The joint 34 is formed on a roof structure 30, which may include a wooden roof decking or sheeting (as illustrated) or which may include other structural support and sheeting members. It should also be kept in mind that the roofing material or product 16 need not be applied directly over the roofing structure 30, but may be applied over an old roof membrane coating (i.e., over old roofing material). Still alternatively, the roofing material 16 may be applied in several successive layers rather in the single layer as is herein depicted and described. Thus, FIG. 6 is provided merely as an example of one possible and exemplary use of the roofing product 16, and the roofing product 16 is in no way to be limited by the example of FIG. 6. As is seen in FIG. 6, the lap joint 34 is formed by applying a first layer of the product 16 to the roof structure 16, as is seen in the right-hand portion of FIG. 6. This layer of product 16 will be applied by removing the release sheet 16a from a strip of the roofing product 16 as this product is unrolled onto the roof structure, recalling FIG. 1. Next, another next-successive strip of the roofing product (as is seen in the left-hand portion of FIG. 6) is applied to the roof structure, with a marginal edge portion 32 overlapping the selvage edge portion 18 of the first (i.e., preceding) strip of roofing product. That is, in the marginal edge portion 32, the adhesive asphaltic material of the layer 16b of the next-successive strip of roofing product is placed over and into contact with the selvage edge portion 18. Next, a weighted roller (not seen in the drawing Figures, but represented by the arrowed character “P” of FIG. 6) is used to press downwardly the marginal edge portion 32 onto the selvage edge portion 18. The result is that the asphaultic material of the layer 16b flows into the sand layer 20 of the selvage edge portion, bonding with the underlying layer 16d of asphaltic material on the underlying layer of product. That is, the sand 20 is not effective to prevent the asphaultic material of layers 16b and 16d from bonding. In fact, the fine-dimension nature of the sand of layer 20 in selvage edge portion facilitates this flowing together and bonding of the successive strips of the product 16 in the lap joint 34. Further, as is indicated by the numbered arrow 34b of FIG. 6, a potential void area adjacent to the side edge 16c′ is filled by material flowing from the adjacent portions of both of the strips of roofing product 16. Additionally, and although FIG. 6 does not so depict a further alteration in the contour of the lap joint 34 in response to the pressure “P”, it will be understood by those ordinarily skilled in the pertinent arts that the side edge 16c″ of the overlapping strip of roofing product is “smeared” down so that the side edge is no longer square cornered or exposed.

Those skilled in the art will further appreciate that the present invention may be embodied in other specific forms without departing from the spirit or central attributes thereof. Because the foregoing description of the present invention discloses only particularly preferred exemplary embodiments of the invention, it is to be understood that other variations are recognized as being within the scope of the present invention. Accordingly, the present invention is not limited to the particular embodiment which has been described in detail herein. Rather, reference should be made to the appended claims to define the scope and content of the present invention.

We claim:

1. An elongate strip-like self-adhesive roofing product, said roofing product comprising:
an elongate strip-like, web of flexible fibrous material having a pair of opposite faces and a pair of elongate opposite side edges;
a pair of layers of asphaltic material, each one of said pair of layers of asphaltic material sandwiching said elongate web of flexible material therebetween, and being congruent with a respective one of said pair of opposite faces of said web of flexible material and bonding thereto so that each of said pair of layers of asphaltic material has a pair of elongate opposite side edges aligning with said web of flexible material;
a bottom one of said pair of layers of asphaltic material carrying a release sheet removably securing thereto and covering said one layer of asphaltic material;
the top one of said pair of layers of asphaltic material defining an elongate major surface portion extending across said roofing product from a first one of said pair of opposite side edges thereof toward but short of the second one of said pair of opposite side edges, said major surface portion carrying granular material embedding in said top layer of asphaltic material; and
said top layer of asphaltic material also defining an elongate selvage edge portion extending from said second side edge to said major surface portion and increasing in thickness away from said second side edge.

2. The roofing product of claim 1 wherein said selvage edge portion increases in thickness progressively away from said second side edge.

3. The roofing product of claim 1 wherein said selvage edge portion increases in thickness step-wise away from said second side edge.

4. The roofing product of claim 1 wherein said selvage edge portion carries a layer of material substantially preventing said top layer of asphaltic material in said selvage edge portion from being undesirably tacky and adhesive.

5. The roofing product of claim 4 wherein said layer of material on said selvage edge portion of said top layer of asphaltic material includes a layer of sand embedded into said top layer of asphaltic material.

6. A roll roofing product comprising:
an elongate strip of roofing material having spaced apart opposite side edges and an elongate first layer of asphaltic adhesive material bonding to one face of an elongate web of fibrous material and extending between said opposite side edges, and a removable release sheet covering said first layer of adhesive material;
an elongate second layer of asphaltic material bonding to an opposite face of said elongate web of fibrous material, and a field of protective granular material covering a major portion of said second layer of asphaltic material and extending from one side edge toward but short of the other opposite side edge to leave an elongate selvage edge portion free of granular material, and said second layer of asphaltic material decreasing in thickness in said selvage edge portion from said field of protective granular material toward said other opposite side edge.

7. The roofing product of claim 6 wherein said selvage edge portion decreases in thickness progressively away from said field of granular material.

8. The roofing product of claim 6 wherein said selvage edge portion decreases in thickness step-wise away from said field of granular material.

9. The roofing product of claim 6 wherein said selvage edge portion carries a layer of material substantially preventing said top layer of asphaltic material in said selvage edge portion from being undesirably tacky and adhesive.

10. The roofing product of claim 9 wherein said layer of material on said selvage edge portion of said top layer of asphaltic material includes a layer of sand embedded into said top layer of asphaltic material.

11. A method of making an elongate strip-like roofing product, said method including steps of:
providing an elongate strip-like web of flexible fibrous material having a pair of opposite faces and a pair of elongate opposite side edges;
applying and bonding a pair of layers of asphaltic material one to each one of said pair of opposite faces and sandwiching said elongate web of flexible material therebetween while providing for said pair of layers of asphalitic material to be congruent with said web of flexible material so that each of said pair of layers of asphaltic material has a pair of elongate opposite side edges aligning with said web of flexible material;
on a bottom one of said pair of layers of asphaltic material providing a release sheet removably securing thereto and covering said one layer of asphaltic material;
on the top one of said pair of layers of asphaltic material defining an elongate major surface portion extending across said roofing product from a first one of said pair of opposite side edges thereof toward but short of the second one of said pair of opposite side edges,
in said major surface portion providing a layer of granular material, and embedding said layer of granular material in said top layer of asphaltic material; and
also in said top layer of asphaltic material defining an elongate selvage edge portion extending from said second side edge to said major surface portion and increasing in thickness away from said second side edge.

12. The method of claim 11 further including the step of increasing the thickness of said selvage edge portion progressively away from said second side edge.

13. The method of claim 11 further including the step of increasing the thickness of said selvage edge portion step-wise away from said second side edge.

14. The method of claim 11 further including the step of providing for said selvage edge portion to carry a layer of material substantially preventing said top layer of asphaltic material in said selvage edge portion from being undesirably tacky and adhesive.

15. The method of claim 14 wherein said step of providing for said selvage edge portion to carry a layer of material preventing said top layer of asphaltic material from being undesirably tacky and adhesive includes providing a layer of sand embedded into said top layer of asphaltic material at said selvage edge portion.

16. A method of providing a roll roofing product, said method comprising steps of: providing an elongate strip of roofing material having spaced apart opposite side edges and an elongate first layer of asphaltic adhesive material bonding to one face of an elongate web of fibrous material and extending between said opposite side edges;
providing a removable release sheet covering said first layer of adhesive material;
providing an elongate second layer of asphaltic material bonding to an opposite face of said elongate web of fibrous material;
providing a field of protective granular material covering a major portion of said second layer of asphaltic material and extending from one side edge toward but short of the other opposite side edge to leave an elongate selvage edge portion free of granular material;
providing for said second layer of asphaltic material to decrease in thickness in said selvage edge portion from said field of protective granular material toward said other opposite side edge.

17. The method of claim 16 further including the step of providing for said selvage edge portion to decrease in thickness progressively away from said field of granular material.

18. The method of claim 16 further including the step of providing for said selvage edge portion to decrease in thickness step-wise away from said field of granular material.

19. The method of claim 16 further including the step of providing for said selvage edge portion to carry a layer of material substantially preventing said top layer of asphaltic material in said selvage edge portion from being undesirably tacky and adhesive.

20. The method of claim 19 wherein said step of providing for said selvage edge portion to carry a layer of material on said selvage edge portion preventing said top layer of asphaltic material from being undesirably tacky and adhesive includes providing a layer of sand embedded into said top layer of asphaltic material within said selvage edge portion.
